(19) United States
(12) Patent Application Publication
(10) Pub. No.: US 2025/0058569 A1
(43) Pub. Date: Feb. 20, 2025

(54) INKJET PRINTING METHOD AND INKJET PRINTING APPARATUS

(71) Applicant: UNIJET CO., LTD., Gyeonggi-do (KR)

(72) Inventors: HEE JUN HAN, Gyeonggi-do (KR); SEOG SOON KIM, Gyeonggi-do (KR); GIL HWAN YEO, Gyeonggi-do (KR)

(21) Appl. No.: 18/724,800

(22) PCT Filed: Oct. 17, 2022
(86) PCT No.: PCT/KR2022/015679

§ 371 Date: Jun. 27, 2024

(30) Foreign Application Priority Data
Dec. 30, 2021 (KR) 10-2021-0192067

(51) Int. Cl. B41J 11/00; B41J 2/045

(52) U.S. Cl. CPC B41J 11/002; B41J 2/04501

(57) ABSTRACT

In a method for forming a thick layer of a thickness on a substrate by using an inkjet printing apparatus comprising a head module for ejecting an ink, a dot print layer is formed such that dot-shaped arrays are formed at predetermined intervals in order to prevent ink droplets, which are deposited on the substrate, from pulling each other, ink is ejected in an amount enabling a thick coating of uniform thickness to be overlapped and printed on the dot print layer, thereby forming a thick print layer with the thickness.

### CROSS REFERENCE TO RELATED APPLICATIONS AND CLAIM OF PRIORITY

This application claims benefit under 35 U.S.C. 119, 120, 121, or 365 (c), and is a National Stage entry from International Application No. PCT/KR2022/015679 filed on Oct. 17, 2022, which claims priority to the benefit of Korean Patent Application No. 10-2021-0192067 filed on Dec. 30, 2021, in the Korean Intellectual Property Office, the entire contents of which are incorporated herein by reference.

### STATEMENT REGARDING FEDERALLY SPONSORED RESEARCH OR DEVELOPMENT

The present invention was supported by the national research and development program; identification number: 1415172773; Project number: 20010022; Government department name: Ministry of Trade, Industry and Energy; Project management (professional) institution name: Korea Planning & Evaluation Institute of Industrial Technology; Research project title: Next-generation hybrid PCB technology development (R&D); Research title: Development for printed electronics method-applied, 30 um line width, and ultrahigh multilayer PCB substrate for use in high speed signaling; Contribution ratio: 1/1; Project performing organization name: ATC.CO., LTD.; Research period Apr. 1, 2020 to Dec. 31, 2023

### BACKGROUND

### 1. Technical Field

The present development technology relates to a technique for controlling an ejection stain inside one inkjet head and a stain generated between in inkjet heads in a printing process using an inkjet printing technique.

### 2. Background Art

Recently, development for high performance displays to improve performance and quality of smartphones due to development such as fourth industrial revolution is ongoing.

A high performance display is provided so that a cover window, a polarizer, a touch sensor panel, and the like are disposed on a top surface of the display, and in order to attach these components and improve optical characteristics of an adhesive, an optically clear adhesive (OCA) or an optically clear resin (OCR), each of which is a transparent adhesive, is used.

The OCA is provided in the form of a solid film, and the OCR is formed in a liquid state.

The OCA is supplied in a standardized size varying depending on a product, with protective films attached to both surfaces thereof, and is used as an adhesive material for bonding components such as a display panel, a window, a touch sensor panel, and a polarizer.

An OCA film has an advantage of being easily handleable in a manufacturing process, but has a disadvantage that as a standardized product is used for one product, when a display product is changed, the OCA film needs to be changed accordingly.

In addition, in a case in which there is a stepped portion of an attachment substrate, an ability to fill the stepped portion may be low due to the characteristic of the solidified adhesive, and a bubble defect may be generated when a foreign matter is introduced. Here, in an optical portion, a fine bubble may be difficult to completely remove to result in a reduction in transmittance.

OCA products have disadvantages that in a small thickness of about 20 μm or less, thickness uniformity is difficult to satisfy, and a probability of failure to detach protective films is high in a process of manufacturing displays to be disadvantageous in application to the display process.

The OCR is a material replacing the OCA, and is an adhesive material that is printed on a substrate in a liquid state and cured to be bonded to another substrate.

Thus, the OCR is used as an adhesive that bonds components variously stacked at the same position as a layer to which the OCA is applied in a display product. For example, the OCR is applied between various layers such as a cover window and a touch sensor panel, a cover window and a display panel, a touch sensor panel and a display panel, a display rear surface and a heating plate, and a heating plate and a buffer.

In the OCA film described above, outer edges thereof are cut, and thus straightness and uniformity of a film thickness is easy to maintain. However, OCR printing has disadvantages that as an ink is spread to the outside on an edge of a printing film, a final thickness may be formed to be less than a targeted thickness, and straightness at the edge of the printing film is lower than that of the OCA.

And a coating method for the OCR may be classified into a slit method and an inkjet method.

The slit coating method is disadvantageous in terms of slit component management and usage when compared to the inkjet method, and the inkjet method has constraints on use according to the viscosity of an OCR material to be used and inkjet head characteristics when compared to the slit method.

In the inkjet printing technique, as one head has a restricted width, the one head may perform printing on a large substrate while reciprocating multiple times. However, there is a problem that the productivity deteriorates due to an increase in printing time according to multiple reciprocal printing operations.

In order to solve the problem, when printing is performed on a substrate having a large width by using a plurality of inkjet heads as illustrated in FIG. 1, the plurality of inkjet heads may be arranged to overlap each other in a head longitudinal direction so that an area having a greater width than the inkjet head at once is printed by one-time printing.

In addition, in a case in which a printing thickness is large, for example, a thickness of 100 μm or more, when a plurality of inkjet head columns are installed to overlap each other on the same printing line, an ink may be applied as much as the number of the inkjet heads so that a thickness larger than a thickness resulting from printing using one inkjet head is printed even by one-time printing.

Thus, in a case in which large-area and large-thickness printing is performed, when several inkjet heads are mounted in each of a longitudinal direction and a printing direction to perform the printing, one-time printing enables the large-area and large-thickness printing.

Meanwhile, in order that deposited ink drops are allowed to remain at dropped positions to achieve uniform coating in a large thickness with one printing operation, a light emitting unit may be mounted behind an inkjet head module so that the ink drops are immediately temporarily cured during coating.

In addition, it is inevitable that an actual printing width by the inkjet head is much less than an actual head width because, in respective structures of almost all the inkjet heads, an ink supply channel structure, which supplies an ink to a head, and a structure for fixing the head are installed at both side surfaces of the head, and head nozzles are disposed at a central portion of the head.

Even for this reason, when the plurality of inkjet heads are connected and arranged in the longitudinal direction, heads have to overlap in two rows at the front and the rear due to mechanism limitations. That is, when the heads are arranged in the longitudinal direction for a surface to be printed not to be exposed, the heads have to be misaligned apart by a head thickness in two rows.

This results in an arrangement in which a difference between nozzle positions of the heads disposed in the front row and the rear row occurs as much as the head width.

This leads to a time difference between ink drops to be printed at a boundary between the heads, and an ink drop first deposited in the front row attracts an ink drop later deposited in the rear row to cause ink gathering. Accordingly, as illustrated in FIG. 2, a difference in thickness occurs to constitute one cause of occurrence a stain.

As a method for solving this problem, there are also heads designed to be continuously connected in one row in a head longitudinal direction as the heads having a rhombus shape have each a central portion at which nozzles in 32 rows are arranged as illustrated in FIG. 3.

When this head is applied, nozzles may cover the entire surface thoroughly to perform printing, even when heads are arranged in one row in printing a region having a greater size than one head.

Thus, the application of heads in which this rhombus shaped head is developed helps reduce stains between the heads which are generated because of the head positions.

However, as a size of the ink drop of this head is restricted, one-time printing in arrangement of heads in one row has a limit to coating in a large thickness.

In addition, nozzle columns inside this head are 32 and there is a big difference between respective positions of the nozzles in a printing direction. Thus, there is a similar problem to that of two-row arrangement of general heads.

Meanwhile, when a plasma process is performed on a substrate surface to be printed in order to improve bonding with the substrate the before inkjet printing, hydrophilicity is improved to improve spreadability of ink drops on the substrate. Due to this spreadability, the ink drops are spread more widely by being seated on the substrate immediately after being ejected from the inkjet head.

The continuously ejected drops are also seated on the substrate, and combined with the previously ejected drops while spreading. Some of respective shapes of the ink drops are maintained immediately after the ink drops are gathered, and as time passes, the gathered ink drops are leveled so that the thickness is uniform.

Meanwhile, as illustrated in FIG. 4, with the ink drops spreading, the ink drops are spread to a wider area than a targeted printing region on an edge of a printing layer of a substrate 100, and this leads to a phenomenon in which the thickness is gently decreased.

In order to compensate for the problem caused by this thickness difference during a bonding process, i.e., to compensate for the decrease in ink thickness at an outer part, an additional printing process may be performed only on the edge so that the height of the edge is increased.

However, printing for a large thickness has a disadvantage that a separate printing process is required to print this edge in a large thickness.

For example, as illustrated in FIG. 5, also in a camera hole inside a display screen of a display, as the hole has been penetrated through a laser process, printing is performed only to a position adjacent to the hole.

As there is the ink spreading phenomenon also at the position adjacent to the hole, there is a problem that processing costs, time and effort are required to form a large thickness through separate additional printing.

### SUMMARY

The objective of the present invention is to provide an inkjet printing method for preventing smearing by improving, when printing a thick layer having a large thickness through inkjet printing, thickness uniformity while forming a desired large thickness.

An inkjet printing method according to the present invention is a method for forming a thick layer having a thickness (t) on a substrate by using an inkjet printing apparatus including a head module that ejects an ink in order to solve the above problems, the method including: a primary printing step (s10) of forming a dot print layer (L1) such that an array in the form of dots with constant spacing is formed to prevent the ink droplets (d), which are deposited on the substrate, from attracting each other; and a secondary printing step (s20) of forming a thick print layer having the thickness (t) by ejecting an ink in an amount to print a thick coating having a uniform thickness to overlap on the dot print layer.

In the inkjet printing method according to the present invention, in the primary printing step (s10), a distance between the dots is formed to be less than a size of an ink droplet ejected in the secondary printing step (s20).

In the inkjet printing method according to the present invention, the primary printing step (s10) is performed while the substrate relatively moves in one direction of a substrate printing direction, and the secondary printing step (s20) is performed while the substrate relatively moves in an opposite direction to the one direction of the substrate printing direction.

The inkjet printing method according to the present invention further includes an ink curing step (s30) of curing the printed ink, and the ink curing step (s30) includes a dot print layer curing step (s31) of curing the dot print layer at a front side in the substrate printing direction in the primary printing step (s30), and a thick print layer curing step (s32) of curing the thick print layer at a rear side in the substrate printing direction in the primary printing step (s30).

In the inkjet printing method according to the present invention, in the thick print layer curing step (s32), at least an edge portion of the thick print layer is cured to prevent non-uniform ink spreading on an edge of the thick print layer when the secondary printing step (s20) is performed.

In the inkjet printing method according to the present invention, the primary printing step (s10) and the secondary printing step (s20) are performed at positions spaced apart from each other in the substrate printing direction.

The inkjet printing method according to the present invention further includes an ink curing step (s30) of curing the printed ink, and the ink curing step (s30) includes a dot print layer curing step (s31) of curing the dot print layer at a front side in the substrate printing direction in the primary printing step (s30), and a thick print layer curing step (s32) of curing the thick print layer at a front side in the substrate printing direction in the secondary printing step (s30).

In the inkjet printing method according to the present invention, in the thick print layer curing step (s32), at least an edge portion of a printing region is cured to prevent non-uniform ink spreading on an edge of the thick print layer during the printing in the secondary printing step (s20).

The inkjet printing method according to the present invention further includes an ink curing step (s30) of curing the ink printed at a rear side in the substrate printing direction in the secondary printing step (s20).

In the inkjet printing method according to the present invention, a plurality of ink droplets are ejected by one signal at the same time or continuously in the secondary printing step (s20) so that the ink is ejected in an amount greater than an amount of the ink ejected in the primary printing step (s30).

In the inkjet printing method according to the present invention, the ink applied in the secondary printing step (s20) is the same ink or an ink having the same surface tension as the ink applied in the primary printing step (s10).

In the inkjet printing method according to the present invention, only the secondary printing step (s20) is additionally performed to increase the thickness (t) of the thick layer.

An inkjet printing apparatus according to the present invention is an inkjet printing apparatus for providing a thick layer having a thickness (t) on a substrate, in order to solve the above problems, the inkjet printing apparatus including a head array module installed above the substrate to eject an ink on the substrate, wherein the head array module is arranged in a direction perpendicular to a substrate printing direction, and provided so that a plurality of heads overlap each other to form an array in the substrate printing direction, wherein the inkjet printing apparatus performs: a primary printing step of forming a dot print layer (L1) to form an array in the form of dots with constant spacing so that the dots are sprayed from the head array module to be prevented from attracting each other while the substrate moves relative to the head array module in the substrate printing direction; and a secondary printing step of forming a thick print layer having a thickness (t) by allowing the head array module to eject an ink in an amount to print a thick coating having a uniform thickness to overlap on the dot print layer, while the substrate moves relative to the head array module in a direction opposite to the substrate printing direction.

In the inkjet printing apparatus according to the present invention, in the primary printing step (s10), a distance between the dots is formed to be less than a size of an ink droplet ejected in the secondary printing step (s20).

The inkjet printing apparatus according to the present invention further includes a curing module that cures the thick layer, and the curing module includes: a first curing module installed in front of the head array module in the substrate printing direction to cure the dot print layer; and a second curing module installed behind the head array module in the substrate printing direction to cure the thick print layer, wherein the first and second curing modules are provided to be moved simultaneously with the head array module forward and backward in the substrate printing direction by the substrate transfer device.

The inkjet printing apparatus according to the present invention further includes a curing module that cures the thick layer, and the curing module includes: a first curing module installed in front of the head array module in the substrate printing direction to cure the dot print layer; and a second curing module installed behind the head array module in the substrate printing direction to cure the thick print layer, wherein the inkjet printing apparatus comprises first and second curing module transfer devices that are installed to be, respectively, connected to the first curing module and the second curing module to transfer the first and second curing modules forward and backward in the substrate printing direction separately from the substrate transfer device.

An inkjet printing apparatus according to the present invention is an inkjet printing apparatus for providing a thick layer having a thickness (t) on a substrate, in order to solve the above problems, the inkjet printing apparatus including: two head array modules, each of which is installed above the substrate to eject an ink on the substrate, wherein the head array module is arranged in a direction perpendicular to a substrate printing direction, and provided so that a plurality of heads overlap each other to form an array in the substrate printing direction, wherein the head array modules include a first head array module installed at a rear side in the substrate printing direction, and a second head array module installed behind the first head array module in the substrate printing direction, wherein the inkjet printing apparatus performs: a primary printing step of forming a dot print layer (L1) to form an array in the form of dots with constant spacing so that the dots are sprayed from the head array module to be prevented from attracting each other while the substrate moves relative to the head array module in the substrate printing direction; and; and a secondary printing step of forming a thick print layer having a thickness (t) by allowing the second head array module to eject an ink in an amount to print a thick coating having a uniform thickness to overlap on the dot print layer.

In the inkjet printing apparatus according to the present invention, in the primary printing step (s10), a distance between the dots is formed to be less than a diameter of an ink droplet ejected in the secondary printing step (s20).

The inkjet printing apparatus according to the present invention further includes first and second head array module transfer devices that are installed to be, respectively, connected to the first head array module and the second head array module to transfer the first and second head array modules forward and backward in the substrate printing direction, wherein the second head array module transfer device adjusts a relative transfer speed of the second head array module to the first head array module so that the secondary printing step is performed after leveling of the ink ejected in the primary printing step is completed.

The inkjet printing apparatus according to the present invention further includes a curing module that cures the thick layer, the curing module including: a first curing module installed behind the first head array module in the substrate printing direction to cure the dot print layer; and a second curing module installed behind the second head array module in the substrate printing direction to cure the thick print layer, wherein the first head array module and the first curing module are provided to be moved forward and backward in the substrate printing direction by the first head array module transfer device, wherein the second head array module and the second curing module are provided to be moved forward and backward in the substrate printing direction by the second head array module transfer device.

The inkjet printing apparatus according to the present invention further includes a curing module that cures the thick layer, the curing module including: a first curing module installed behind the first head array module in the substrate printing direction to cure the dot print layer; and a second curing module installed behind the second head array module in the substrate printing direction to cure the thick print layer, wherein the inkjet printing apparatus comprises first and second curing module transfer devices that are installed to be, respectively, connected to the first curing module and the second curing module to transfer the first and second curing modules forward and backward in the substrate printing direction separately from the first and second substrate transfer device.

The inkjet printing apparatus according to the present invention further includes a curing module that cures the thick layer, wherein the curing module is installed behind the second head array module in the substrate printing direction, wherein the curing module and the second head array module are provided to be moved forward and backward in the substrate printing direction by the second head array module transfer device.

The inkjet printing apparatus according to the present invention further includes a curing module that cures the thick layer, wherein the curing module is installed behind the second head array module in the substrate printing direction, wherein the inkjet printing apparatus includes a curing module transfer device that is installed to be connected to the curing module to transfer the curing module forward and backward in the substrate printing direction separately from the first and second substrate transfer device.

The present invention operates so that the first printing is performed on the entirety surface in the small thickness, and then the second printing is performed or the inkjet printing is performed multiple times to form the targeted thickness.

Accordingly, even in the printing process in which the several inkjet heads are used to rapidly form the thick film having the large thickness on the large area, the printing smear generated due to the deviation and position difference between the inkjet heads, the deviation between the nozzles, and the difference in surface state of the substrate is removed to have the effect of improving the display quality.

In addition, there is the advantage that the additional process for the increase in height of the edge is not performed to prevent the edge spreading unlike the related art.

The thick film layer having the targeted large thickness as above and also having the uniform thickness may be utilized as the buffer, the hard coating agent of the cover window, the protective film of the bending area, or the like, in addition to the OCR of the display product.

### BRIEF DESCRIPTION OF THE DRAWINGS

FIG. 1 is a view illustrating a head array of an inkjet printing apparatus according to the related art.

FIG. 2 is a view illustrating a phenomenon in which stains occurs when printing is performed using an inkjet printing apparatus according to the related art.

FIG. 3 is a view illustrating a configuration of a head having a rhombus shape according to the related art.

FIG. 4 is a view illustrating an ink spreading phenomenon on an edge of a printing region according to the related art.

FIG. 5 is a view illustrating an ink spreading phenomenon on an edge of a smartphone camera hole according to the related art.

FIG. 6 is a view illustrating a reciprocating

printing type of an inkjet printing apparatus according to an embodiment of the present invention.

FIG. 7 is a view illustrating an embodiment in which a curing module is separately driven in FIG. 6.

FIG. 8 is a view illustrating a unidirectional printing type of an inkjet printing apparatus according to an embodiment of the present invention.

FIG. 9 is a view illustrating an embodiment in which a curing module is separately driven in FIG. 8.

FIG. 10 is a view illustrating a unidirectional

printing type of an inkjet printing apparatus according to another embodiment of the present invention.

FIG. 11 is a view illustrating an embodiment in which a curing module is separately driven in FIG. 10.

FIG. 12 is a view illustrating a primary printing step of an inkjet printing method according to the present invention.

FIG. 13 is a view illustrating a secondary printing step of an inkjet printing method according to the present invention.

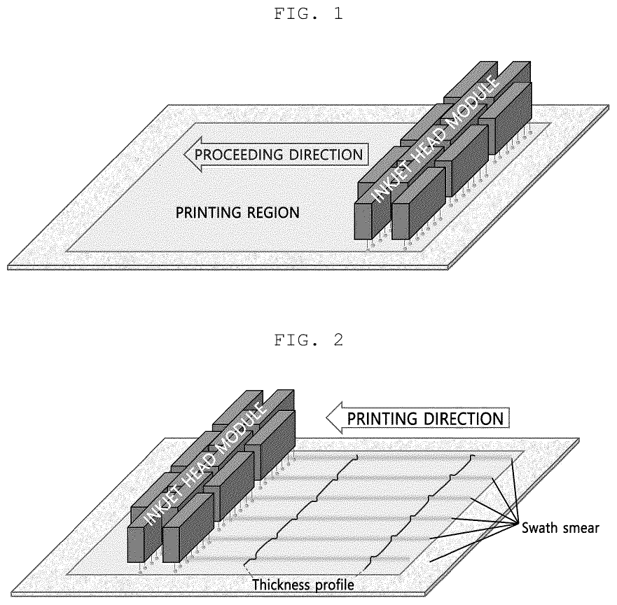

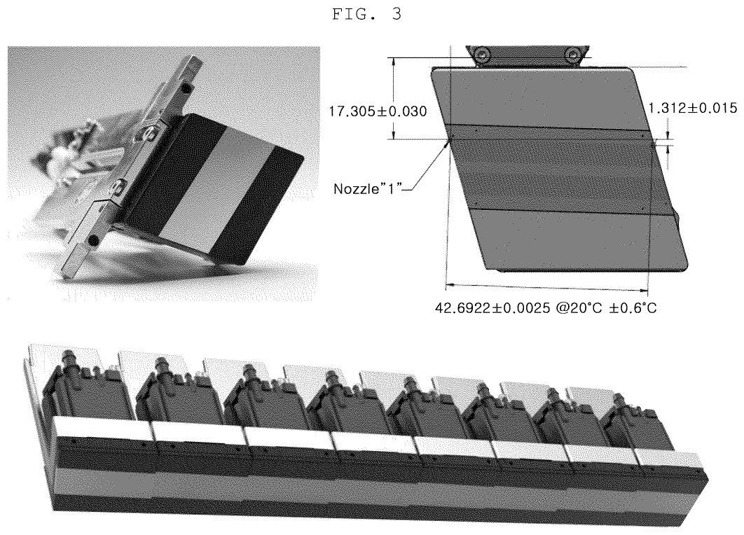

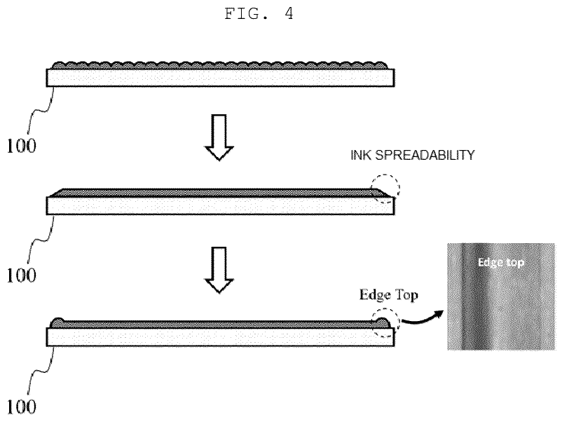

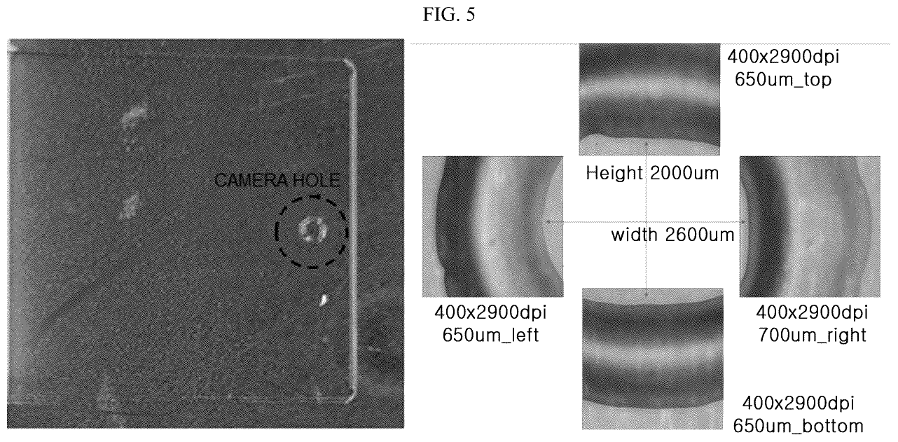

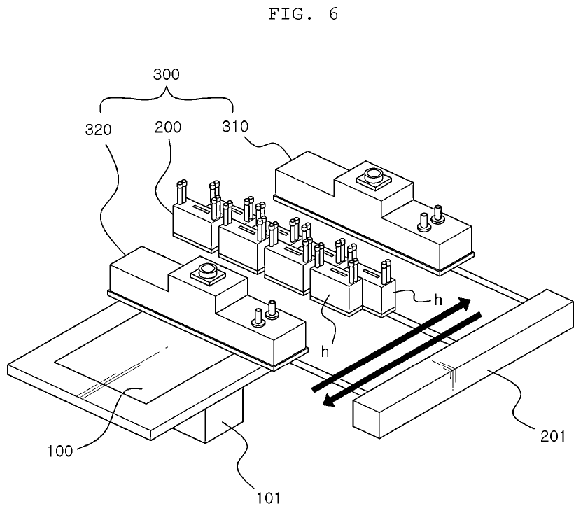

### DETAILED DESCRIPTION

Hereinafter, embodiments of the present invention will be described with reference to the drawings.

### [Inkjet Printing Apparatus]

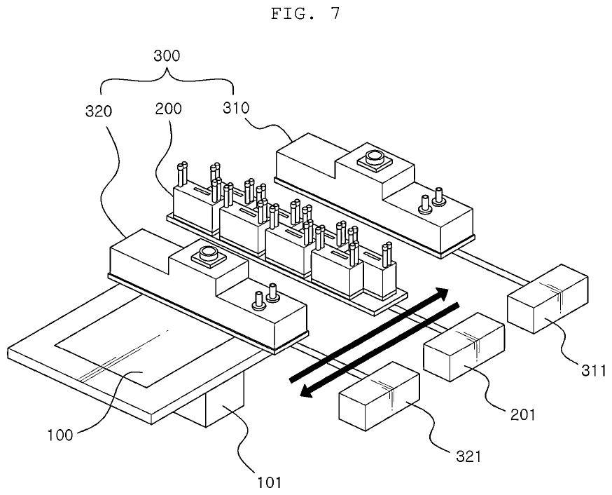

FIG. 6 is a view illustrating a reciprocating printing type of an inkjet printing apparatus according to an embodiment of the present invention.

The inkjet printing apparatus according to an embodiment of the present invention may basically include a substrate which is an object to be printed, a head array module which ejects an ink onto the substrate, and a curing module which cures the ink ejected from the head array module.

Components, which are not separately described, of the inkjet printing apparatus according to the present invention are provided and operated the same as those of a general inkjet printing apparatus, and there is only a difference in arrangement of the head array module and the curing module as described later.

In the present invention, the inkjet printing apparatus may have several arrangements due to the number of each of an inkjet head module and an ultraviolet light curing module, and a proceeding direction of the substrate, an operation time interval of each module, and the like. Specifically, the inkjet printing apparatus may be provided in a reciprocating printing type and a unidirectional printing type.

### [First Embodiment_Reciprocating Printing Type_Curing Module Simultaneously Operating Type]

A reciprocating printing type of the inkjet printing apparatus according to the present invention includes a substrate transfer device 101 that transfers a substrate 100 in a substrate printing direction, a head array module transfer device 201 that transfers a head array module 200, which is installed above the substrate transfer module 100, in the substrate printing direction, and first and second curing modules 310 and 320 installed, respectively, in front of and behind the head array module 200 in the substrate printing direction.

The substrate 100 is defined as one including various objects to be printed, for example, a wafer, a glass substrate, or the like.

The substrate transfer device 101 is installed below the substrate 100 to operate to move the substrate 100 forward and backward in the substrate printing direction.

The substrate transfer device 101 is provided as a known component that is generally installed inside the inkjet printing apparatus, and may be provided as, for example, a linear motor, a linear motion guide, or the like.

The head array module 200 is arranged in a direction perpendicular to the substrate printing direction, and provided so that a plurality of heads h overlap each other to form an array in the substrate printing direction.

The head array module transfer device 201, which is a known component, is installed to be connected to the head array module 200 inside the inkjet printing apparatus, and is provided to operate to move the head array module 200 forward and backward in the substrate printing direction.

The head array module transfer device 201 is provided as a known component that is generally installed inside the inkjet printing apparatus, and may be provided as, for example, a linear motor, a linear motion guide, or the like.

The curing modules include the first curing module 310, which is installed in front of the head array module 200 in the substrate printing direction to cure a dot print layer, and the second curing module 320 which is installed behind the head array module 200 in the substrate printing direction to cure a thick print layer.

Each of the first and second curing modules 310 and 320 includes a known thermal curing device or light curing device.

In this embodiment, as illustrated in FIG. 6, the first and second curing modules 310 and 320 are provided to be moved simultaneously with the head array module 200 by the head array module transfer device 201.

### [Second Embodiment_Reciprocating Printing Type_Curing Module Separately Operating Type]

FIG. 7 is a view illustrating an embodiment in which a curing module is separately driven in FIG. 6.

In another embodiment of the reciprocating printing type, the curing modules may be provided to include respective transfer devices separately from the head array module transfer device 201 when necessary.

That is, as illustrated in FIG. 7, a first curing module transfer device 311, which transfers the first curing module 310 forward and backward in the substrate printing direction, and a second curing module transfer device 321, which transfers the second curing module 320 forward and backward in the substrate printing direction, may each be provided to operate separately from the head array module transfer device 201.

Each of the first and second curing module transfer devices 311 and 321 is provided as a known component that is generally installed inside the inkjet printing apparatus, and may be provided as, for example, a linear motor, a linear motion guide, or the like.

Each of the reciprocating printing type inkjet printing apparatuses according to the first and second embodiments allows the substrate transfer device 101 to transfer the substrate 100 forward in the substrate printing direction to perform a primary printing step (s10) while the substrate 100 moves relative to the head array module 200, and allows the substrate transfer device 101 to transfer the substrate 100 backward in the substrate printing direction to perform a secondary printing step (s20) while the substrate 100 moves relative to the head array module 200.

Here, the substrate transfer device 101 adjusts a relative transfer speed of the substrate 100 in a reverse direction to perform the secondary printing step (s20).

Alternatively, the substrate 100 may be fixed, and the head array module transfer device 201 may adjust a relative transfer speed of the head array module 200 in a direction opposite to the substrate printing direction so that the secondary printing step (s20) is performed.

In the second embodiment in which the first and second curing module transfer devices 311 and 321 are provided separately from the head array module transfer device 201, a curing rate or time after the primary printing step (s10) and/or the secondary printing step (s20) may be adjusted through the first and second curing module transfer devices 311 and 321.

### [Third Embodiment Unidirectional Printing Type_Two Curing Modules Simultaneously Operating Type]

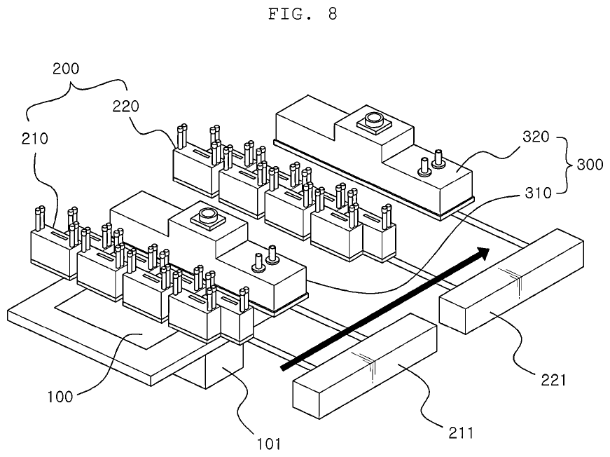

FIG. 8 is a view illustrating a unidirectional printing type of an inkjet printing apparatus according to an embodiment of the present invention.

As illustrated in FIG. 8, a unidirectional printing type of an inkjet printing apparatus according to present invention includes a substrate transfer device 101, which transfers a substrate 100 in a substrate printing direction, a first head array module 210, which is installed above the substrate transfer module 100 and at a rear side in the substrate printing direction to preform primary printing of printing a dot print layer, a second head array module 220, which is installed at the rear side in the substrate printing direction to preform secondary printing of printing a thick print layer, a first curing module 310, which is installed behind the first head array module 220 in the substrate printing direction to cure the dot print layer, a second curing module 320, which is installed behind the second head array module 220 in the substrate printing direction to cure the thick print layer, a first head array module transfer device 211, which transfers the first head array module 210 and the first curing module 310 at the same time forward and backward in the substrate printing direction, and a second head array module transfer device 221 which transfers the second head array module 220 and the second curing module 330 at the same time forward and backward in the substrate printing direction.

In the third embodiment, two head array modules are spaced a distance from each other in the substrate printing direction so that the printing is performed only in one direction. In this the aspect, third embodiment is distinguished from the first and second embodiments in which only one head array module is provided as the printing direction is a reciprocation direction.

### [Fourth Embodiment Unidirectional Printing Type_Ccuring Module Separately Operating Type]

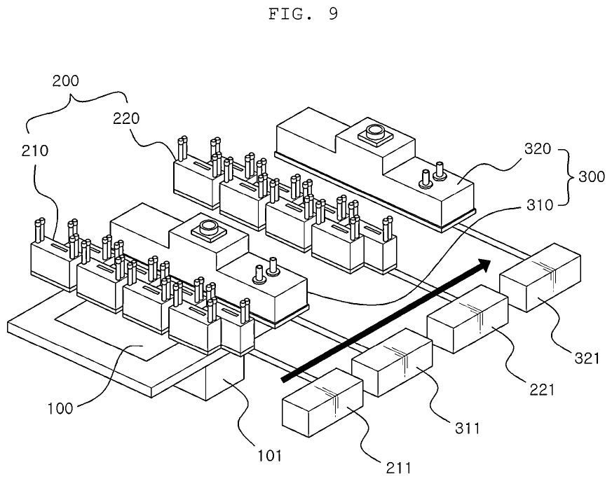

FIG. 9 is a view illustrating an embodiment in which a curing module is separately driven in FIG. 8.

That is, as illustrated in FIG. 9, the fourth embodiment may be provided so that a first head array module transfer device 211 transfers a first head array module 210 alone, a first curing module transfer device 311 which transfers a first curing module 310 forward and backward in the substrate printing direction is separately installed, a second head array module transfer device 221 transfers a second head array module 220 alone, and a second curing module transfer device 321 which transfers a second curing module 320 forward and backward in the substrate printing direction is separately installed.

The fourth embodiment is different from the third embodiment in that the first and second curing modules are operated separately from the first and second head array modules, and the other components and operations are the same.

### [Fifth Embodiment Unidirectional Printing Type_One Curing Module Simultaneously Operating Type]

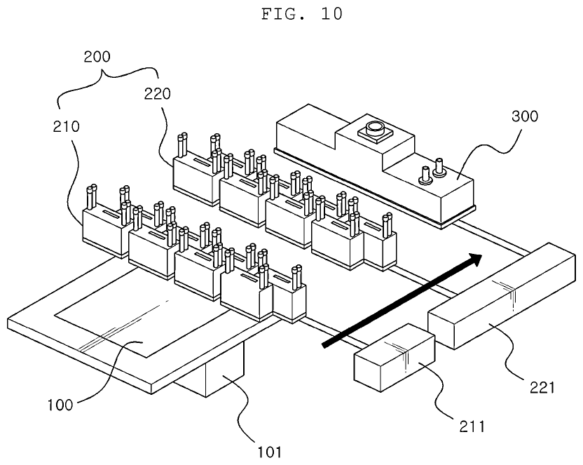

FIG. 10 is a view illustrating a unidirectional printing type of an inkjet printing apparatus according to another embodiment of the present invention.

In the unidirectional printing type of inkjet printing apparatus according to the fifth embodiment of the present invention, only one curing module 300 is installed behind a second head array module 220.

That is, as illustrated in FIG. 10, the inkjet printing apparatus according to the fifth embodiment includes a substrate transfer device 101, which transfers a substrate 100 in a substrate printing direction, a first head array module 210, which is installed above the substrate transfer module 100 and at a rear side in the substrate printing direction to perform primary printing of printing a dot print layer, a second head array module 220, which is installed at the rear side in the substrate printing direction to perform secondary printing of printing a thick print layer, a first head array module transfer device 211, which transfers the first head array module 210 forward and backward in the substrate printing direction, and a second head array module transfer device 221 which transfers the second head array module 220 and the curing module 300 at the same time forward and backward in the substrate printing direction.

The fifth embodiment is different from the third embodiment in that the curing module includes only one, but not the first and second curing modules, and the other components and operations are the same.

### [Sixth Embodiment Unidirectional Printing Type_One Curing Module Separately Operating Type]

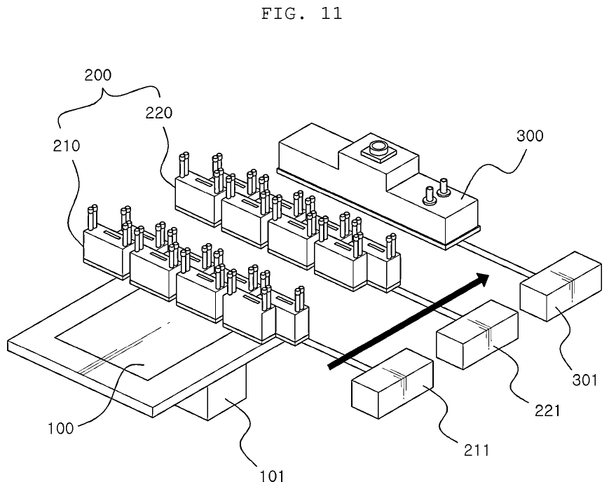

FIG. 11 is a view illustrating an embodiment in which a curing module is separately driven in FIG. 10.

Also in this embodiment, a curing module 300 may be provided to be operated by a separate driving device.

That is, as illustrated in FIG. 11, an inkjet printing apparatus according to the sixth embodiment may be provided so that a second curing module transfer device 321 transfers only a second head array module 220 forward and backward in the substrate printing direction, and a curing module transfer device 301 that transfers the curing module 300 forward and backward in the substrate printing direction is separately installed.

The sixth embodiment is different from the fifth embodiment only in that the curing module 200 may be operated separately from the second head array module 220, and the other components and operations are the same.

Each of the unidirectional printing type inkjet printing apparatuses according to the third to sixth embodiments allows the substrate transfer device 101 to transfer the substrate 100 forward in the substrate printing direction to perform a primary printing step (s10) while the substrate 100 moves relative to the first head array module 210, and allows the substrate transfer device 101 to continuously transfer the substrate 100 forward in the substrate printing direction to perform a secondary printing step (s20) while the substrate 100 moves relative to the second head array module 220.

Like the case in FIG. 8, the transfer speed of the substrate transfer device 101 is adjusted so that the substrate 200 approaches to the second head array module 220 after the primary printing step (s10) by the first head array module 210.

Alternatively, the substrate 100 may be fixed, and the second head array module transfer device 220 may adjust a relative speed of the second head array module 220 to the first head array module 210 in the substrate printing direction so that the secondary printing step (s20) starts after the primary printing step (s10).

In the fourth embodiment in which the first and second curing module transfer devices 311 and 321 are provided separately from the first and second head array module transfer devices 211 and 221, a curing rate or time after the primary printing step (s10) or the secondary printing step (s20) may be adjusted through the first and second curing module transfer devices 311 and 321.

In addition, in the sixth embodiment in which the curing module transfer device 301 is provided separately from the second head array module transfer device 221, a curing rate or time after the secondary printing step may be adjusted through the curing module transfer device 301.

### [Inkjet Printing Method]

An inkjet printing method using the inkjet printing apparatus according to the present invention is as follows.

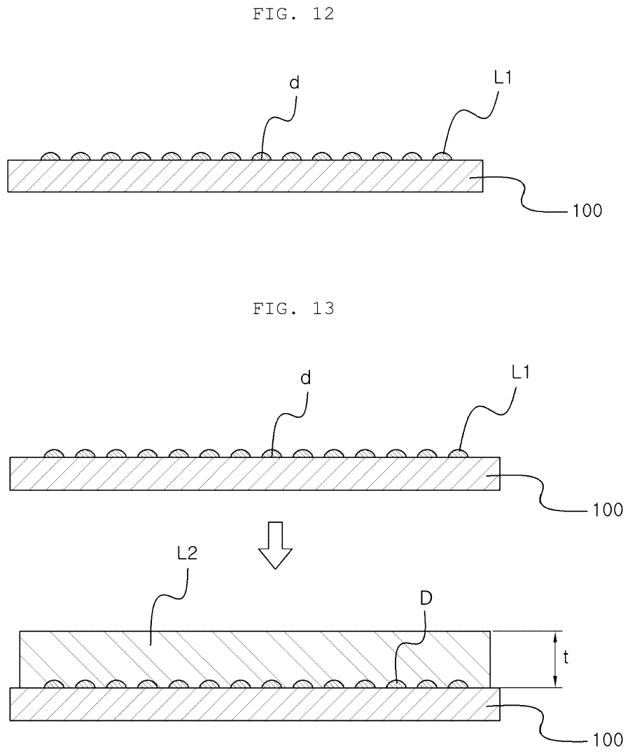

FIG. 12 is a view illustrating a primary printing step of an inkjet printing method according to the present invention.

A thickness t of a thick layer L printed through the

inkjet printing method according to the present invention means generally having a large thickness t of 20 μm or more.

First, a primary printing step (s10) is performed of forming a dot print layer L1 so that ink droplets d deposited on a substrate form an array in the form of dots with constant spacing so as to prevent the ink droplets d from attracting each other.

In order to form the array in the form of dots to prevent the ink droplets deposited on the substrate d from attracting each other, an ejection amount of each of the droplets ejected in the primary printing step (s10) is provided to be less than an ejection amount of a droplet ejected in secondary printing.

This formation of the dot print layer in the primary printing step (s10) affects surface characteristics of the substrate to have a state in which the substrate surface characteristics are substituted as in a case in which an ink is uniformly printed.

In addition, when the respective ejection amounts of the ink droplets ejected in the primary printing step (s10) are the same, respective heights and diameters of the ink droplets are uniform to be advantageous in securement of a flatness of a thick layer through the secondary printing step.

Forming a distance between the dots to be less than a diameter of an ink droplet ejected in a secondary printing step (s20) is advantageous in formation of a uniform thick layer in the secondary printing step (s20).

In the primary printing step (s10), as the ink droplets are printed in the form of dots, time is less required for stabilization such as curing.

FIG. 13 is a view illustrating a secondary printing step of an inkjet printing method according to the present invention.

Next, a secondary printing step (s20) is performed of forming a thick print layer L2 having a thickness t by ejecting an ink in an amount to print a thick coating having a uniform thickness to overlap on the dot print layer L1.

An inkjet ejection amount is primarily obtained by using an area and thickness printed, and as contraction of an ink occurs through ultraviolet curing, this is complemented to finally determine the ejection amount.

A contraction rate is obtained by measuring an initially ejected ink amount and calculating a difference with a volume measured after curing the ink using an ultraviolet curing device.

As above, in the secondary printing step (s20), when a lot of ink droplets are ejected to form the thick layer, first ejected ink droplets are first held by the dot print layer formed in the primary printing.

The surface characteristics of the substrate are substituted the same as the surface characteristics of the ink through the primary printing step to have the same surface tension. Thus, the ink droplets in the secondary printing step may be uniformly formed on the dot print layer to form a uniform thick layer.

Thus, even when a larger amount of ink is ejected to additionally perform the secondary printing step in order that the thickness of the thick layer is increased after the secondary printing step, the thick layer that has no stain, is uniform, and has a larger thickness may be formed.

In addition, the dots in the dot array in the primary printing step are formed not to attract each other, and thus serve as reference points for depositing the ink droplets in the secondary printing step.

Due to the constant amount of the ejected ink, the dot print layer in the primary printing step (s10) has a uniform height and diameter and is arranged with constant spacing. Thus, the dot print layer advantageously affects the formation of the thick layer having no stains and having a uniform thickness.

In the inkjet printing method according to the present invention, the thick print layer L2 is formed to overlap a printing region in which the dot print layer L1 is formed. Thus, the thick print layer L2 is printed and cured only at a position at which the dot print layer L1 is formed.

Accordingly, due to the surface tension of the ink formed on the dot print layer L1, the edge spreading does not occur even after the thick print layer L2 is ejected.

Thus, as a separate edge height-increasing printing process is not additionally performed to prevent the edge spreading unlike the related art, there is an advantage that the number of processes is reduced.

This advantage is more effective in that a separate edge height-increasing process is unnecessary even when a thick layer is formed not in a linear shape but in a curved shape, particularly at a rounded portion of an edge of a smartphone, or around a camera hole of the smartphone.

The reciprocating printing g type inkjet printing apparatus according to the present invention performs the primary printing step (s10) in one direction of the substrate printing direction, and performs the secondary printing step (s20) in a direction opposite to the one direction of the substrate printing direction after the leveling time passes.

In the reciprocating printing type inkjet printing apparatus, a process time required for the primary and secondary printing is a time for reciprocating the substrate 100.

In the other hand, in the unidirectional printing type inkjet printing apparatus according to the present invention, the printing operation is completed even when the substrate 100 moves only in one direction of the printing direction.

Thus, in the unidirectional printing type inkjet printing apparatus, a process time required for the primary and secondary printing is a time for unidirectionally transferring the substrate 100, and thus there is an advantageous effect in the aspect of improvement in productivity.

Alternatively, in order to form the thick print layer, a plurality of ink droplets may be ejected by one signal at the same time or continuously in the secondary printing step (s20) so that the ink is ejected in an amount greater than an ink amount ejected in the primary printing step (s30).

The ink applied in the secondary printing step (s20)

is the same ink or an ink having the same surface tension as the ink applied in the primary printing step (s10).

When the thickness t of the thick layer is formed to be greater, only the secondary printing step (s20) may be additionally continuously performed.

The inkjet printing apparatus according to the present invention includes a curing step s30.

In the reciprocating printing type inkjet printing apparatus, the ink curing step s30 includes a dot print layer curing step (s31) of curing the dot print layer at the front side in the substrate printing direction in the primary printing step (s30), and a thick print layer curing step (s32) of curing the thick print layer at the rear side in the substrate printing direction in the secondary printing step (s30).

In the unidirectional printing type inkjet printing apparatus, the ink curing step (s30) includes a dot print layer curing step (s31) of curing the dot print layer at the front side in the substrate printing direction in the primary printing step (s30), and a thick print layer curing step (s32) of curing the thick print layer at the front side in the substrate printing direction in the secondary printing step (s30).

A temporal or complete curing step for the primary printing may be selectively performed when necessary.

The curing step for the secondary printing is fundamentally included, and particularly, the secondary printing curing step may be applied to the entirety of the thick print layer L2 including the edge or applied to at least the edge of the thick print layer L2.

As the curing step is applied to at least the edge of the thick print layer, the present invention has an effect that an additional printing process of increasing the edge height to prevent the ink spreading on the edge is unnecessary unlike the related art.

Although the preferred embodiments of the present invention have been described, it will be apparent to those skilled in the art that the present invention is not limited to the embodiments set forth herein, and may be embodied in different forms without departing from the spirit and scope of the present invention.

1. An inkjet printing method for forming a thick layer having a thickness on a substrate by using an inkjet printing apparatus comprising a head module configured to eject an ink, the method comprising:
a primary printing step of forming a dot print layer so that an array in the form of dots with constant spacing is formed to prevent the ink droplets, which are deposited on the substrate, from attracting each other; and
a secondary printing step of forming a thick print layer having the thickness by ejecting an ink in an amount to print a thick coating having a uniform thickness to overlap on the dot print layer.

2. The inkjet printing method of claim 1, wherein, in the primary printing step, a distance between the dots is formed to be less than a size of an ink droplet ejected in the secondary printing step.

3. The inkjet printing method of claim 2, wherein the primary printing step is performed while the substrate relatively moves in one direction of a substrate printing direction, and the secondary printing step is performed while the substrate relatively moves in an opposite direction to the one direction of the substrate printing direction.

4. The inkjet printing method of claim 3, further comprising an ink curing step of curing the printed ink, wherein the ink curing step comprises:
a dot print layer curing step of curing the dot print layer at a front side in the substrate printing direction in the primary printing step; and
a thick print layer curing step of curing the thick print layer at a rear side in the substrate printing direction in the primary printing step.

5. The inkjet printing method of claim 4, wherein, in the thick print layer curing step, at least an edge portion of the thick print layer is cured to prevent non-uniform ink spreading on an edge of the thick print layer when the secondary printing step is performed.

6. The inkjet printing method of claim 2, wherein the primary printing step and the secondary printing step are performed at positions spaced apart from each other in the substrate printing direction.

7. The inkjet printing method of claim 6, further comprising an ink curing step of curing the printed ink, wherein the ink curing step comprises:
a dot print layer curing step of curing the dot print layer at a front side in the substrate printing direction in the primary printing step; and
a thick print layer curing step of curing the thick print layer at the front side in the substrate printing direction in the secondary printing step.

8. The inkjet printing method of claim 7, wherein, in the thick print layer curing step, at least an edge portion of a printing region is cured to prevent non-uniform ink spreading on an edge of the thick print layer during the printing in the secondary printing step.

9. The inkjet printing method of claim 6, further comprising an ink curing step of curing the ink printed at a rear side in the substrate printing direction in the secondary printing step.

10. The inkjet printing method claim 1, wherein a plurality of ink droplets are ejected by one signal at the same time or continuously in the secondary printing step so that the ink is ejected in an amount greater than an amount of the ink ejected in the primary printing step.

11. The inkjet printing method of claim 1, wherein the ink applied in the secondary printing step is the same ink or an ink having the same surface tension as the ink applied in the primary printing step.

12. The inkjet printing method of claim 1, wherein only the secondary printing step is additionally performed to increase the thickness of the thick layer.

13. An inkjet printing apparatus for providing a thick layer having a thickness on a substrate, the inkjet printing apparatus comprising:
a head array module installed above the substrate to eject an ink on the substrate,
wherein the head array module is arranged in a direction perpendicular to a substrate printing direction, and provided so that a plurality of heads overlap each other to form an array in the substrate printing direction,
wherein the inkjet printing apparatus is configured to perform:
a primary printing step of forming a dot print layer to form an array in the form of dots with constant spacing so that the dots are sprayed from the head array module to be prevented from attracting each other while the substrate moves relative to the head array module in the substrate printing direction; and
a secondary printing step of forming a thick print layer having a thickness by allowing the head array module to eject an ink in an amount to print a thick coating having a uniform thickness to overlap on the dot print layer, while the substrate moves relative to the head array module in a direction opposite to the substrate printing direction.

14. The inkjet printing apparatus of claim 13, wherein, in the primary printing step, a distance between the dots is formed to be less than a size of an ink droplet ejected in the secondary printing step.

15. The inkjet printing apparatus of claim 14, further comprising a curing module configured to cure the thick layer, wherein the curing module comprises:
a first curing module installed in front of the head array module in the substrate printing direction to cure the dot print layer; and
a second curing module installed behind the head array module in the substrate printing direction to cure the thick print layer,
wherein the first and second curing modules are provided to be moved simultaneously with the head array module forward and backward in the substrate printing direction by the substrate transfer device.

16. The inkjet printing apparatus of claim 13, further comprising a curing module configured to cure the thick layer, the curing module comprising:
a first curing module installed in front of the head array module in the substrate printing direction to cure the dot print layer; and
a second curing module installed behind the head array module in the substrate printing direction to cure the thick print layer,
wherein the inkjet printing apparatus comprises first and second curing module transfer devices that are installed to be, respectively, connected to the first curing module and the second curing module to transfer the first and second curing modules forward and backward in the substrate printing direction separately from the substrate transfer device.

17. An inkjet printing apparatus for providing a thick layer having a thickness on a substrate, the inkjet printing apparatus comprising:
two head array modules, each of which is installed above the substrate to eject an ink on the substrate,
wherein the head array module is arranged in a direction perpendicular to a substrate printing direction, and provided so that a plurality of heads overlap each other to form an array in the substrate printing direction,
wherein the head array modules comprise a first head array module installed at a rear side in the substrate printing direction, and a second head array module installed behind the first head array module in the substrate printing direction,
wherein the inkjet printing apparatus is configured to perform:
a primary printing step of forming a dot print layer (L1) to form an array in the form of dots with constant spacing so that the dots are sprayed from the head array module to be prevented from attracting each other while the substrate moves relative to the head array module in the substrate printing direction; and
a secondary printing step of forming a thick print layer having a thickness by allowing the second head array module to eject an ink in an amount to print a thick coating having a uniform thickness to overlap on the dot print layer.

18. The inkjet printing apparatus of claim 17, wherein, in the primary printing step, a distance between the dots is formed to be less than a diameter of an ink droplet ejected in the secondary printing step.

19. The inkjet printing apparatus of claim 18, further comprising first and second head array module transfer devices that are installed to be, respectively, connected to the first head array module and the second head array module to transfer the first and second head array modules forward and backward in the substrate printing direction,
wherein the second head array module transfer device adjusts a relative transfer speed of the second head array module to the first head array module so that the secondary printing step is performed after leveling of the ink ejected in the primary printing step is completed.

20. The inkjet printing apparatus of claim 19, further comprising a curing module configured to cure the thick layer, wherein the curing module comprises:
a first curing module installed behind the first head array module in the substrate printing direction to cure the dot print layer; and
a second curing module installed behind the second head array module in the substrate printing direction to cure the thick print layer,
wherein the first head array module and the first curing module are provided to be moved forward and backward in the substrate printing direction by the first head array module transfer device,
wherein the second head array module and the second curing module are provided to be moved forward and backward in the substrate printing direction by the second head array module transfer device.

21. The inkjet printing apparatus of claim 20, further comprising a curing module configured to cure the thick layer, wherein the curing module comprises:
a first curing module installed behind the first head array module in the substrate printing direction to cure the dot print layer; and
a second curing module installed behind the second head array module in the substrate printing direction to cure the thick print layer,
wherein the inkjet printing apparatus comprises first and second curing module transfer devices that are installed to be, respectively, connected to the first curing module and the second curing module to transfer the first and second curing modules forward and backward in the substrate printing direction separately from the first and second substrate transfer device.

22. The inkjet printing apparatus of claim 21, further comprising a curing module configured to cure the thick layer,
wherein the curing module is installed behind the second head array module in the substrate printing direction,
wherein the curing module and the second head array module are provided to be moved forward and backward in the substrate printing direction by the second head array module transfer device.

23. The inkjet printing apparatus of claim 22, further comprising a curing module configured to cure the thick layer,
wherein the curing module is installed behind the second head array module in the substrate printing direction,
wherein the inkjet printing apparatus comprises a curing module transfer device that is installed to be connected to the curing module to transfer the curing module forward and backward in the substrate printing direction separately from the first and second substrate transfer device.
